(19) United States
(12) Patent Application Publication
(10) Pub. No.: US 2007/0159853 A1
(43) Pub. Date: Jul. 12, 2007

(54) Backlight module

(75) Inventor: Shi-Ping Xu, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/541,925

(22) Filed: Oct. 2, 2006

(30) Foreign Application Priority Data
Jan. 12, 2006 (CN) 200610032899.0

(51) Int. Cl. F21V 7/04

(52) U.S. Cl. 362/633

(57) ABSTRACT

A backlight module includes a frame, a light guide plate, a FPCB and a plurality of point light sources. The light guide plate has a light incident surface. The point light sources are electrically connected with one surface of the FPCB, each point light source having an emitting surface. The frame includes a plurality of connecting sidewalls encircling the light guide plate. An inner surface of the sidewall facing the light incident surface defines a plurality of elastic members thereon according to the point light sources. Each elastic member pushes the corresponding point light source towards the light guide plate, so as to have the final position of the emitting surface of each point light source come in contact with the light incident surface. The present backlight module has a highly light energy utilization rate.

### TECHNICAL FIELD

The present invention relates to backlight modules, more particularly, to a edge lighting type backlight module for use in, for example, a liquid crystal display (LCD) device.

### BACKGROUND

Flexible printed circuit boards (called FPCBs hereafter) are widely used in electronic devices for electrical connection requiring elasticity and light weight, enabling an internal space of electronics to be effectively utilized and convenient to assembled.

Referring to FIG. 6, a typical backlight module 10 used in a LCD device is shown. The backlight module 10 includes a light guide plate 12, a frame 14, a plurality of light emitting diodes 16 (called LEDs hereafter), and a FPCB 18. The light guide plate 12 includes a light incident surface 122 located at a side thereof and a bottom surface (not labeled) adjoining the light incident surface 122. The frame 14 includes four connecting sidewalls 141 encircling the light guide plate 12. An inner surface of the sidewall 141 of the frame 14 facing the light incident surface 122 defines a plurality of frame cutouts 142 thereon for receiving LEDs 16 correspondingly.

Referring to FIG. 7, the FPCB 18 is generally long and thin. The LEDs 16 are electrically fixed on one surface of the FPCB 18 in an array according to the frame cutouts 142 along a direction parallel to the light incident surface 122. The LEDs 16 each has an emitting surface 162 that is facing the same side of the FPCB 18. The FPCB 18 can be fixed to the bottom surface of the light guide plate 12 by using a double-coated adhesive tape 182. One adhesive surface of the double-coated adhesive tape 182 adheres to one edge of the surface of the FPCB 18 adjacent the emitting surfaces of the LEDs 16, another adhesive surface of the double-coated adhesive tape 182 adheres to the bottom surface adjacent the light incident surface 122 of the light guide plate 12, the LEDs 16 being inserted into the frame cutouts 142 correspondingly.

However, because the LEDs 16 are substantial small and the FPCB 18 is flexible and thin, it is difficult to weld the LEDs 16 to the FPCB 18 precisely, thereby positions of the emitting surfaces 162 of the LEDs 16 are not easily defined in a imaginary line parallel to the light incident surface 122. This result in that the emitting surfaces 162 of the LEDs 16 cannot be positioned in contact with the light incident surface 122 at the same time when assembling. Therefore, a significant amount of light rays from the emitting surfaces 162 of the LEDs 16 escape through gaps between the light guide plate 12 and the LEDs 16. A light energy utilization rate of the backlight module 10 is decrease.

Referring to FIG. 8, another typical backlight module 20 is shown. The backlight module 30 is similar in principle to the backlight module 10, except that the backlight module 30 further includes a plurality of positioning protrusions 344 defined in each corresponding frame cutout 342. The positioning protrusions 344 are configured for positioning LEDs 36 adjacent to light incident surface 322 of light guide plate 32. However, mechanical errors when assembling still exists, and it is also said that gaps between the light guide plate 32 and the LEDs 36 are decreases the light energy utilization rate of the backlight module 30.

What is needed, therefore, is a backlight module that overcome the above mentioned shortcomings.

### SUMMARY

A backlight module according to a preferred embodiment includes a frame, a light guide plate, a FPCB and a plurality of point light sources. The light guide plate has a light incident surface. The point light sources are electrically connected with a surface of the FPCB, each point light source having an emitting surface. The frame includes a plurality of connecting sidewalls encircling the light guide plate. An inner surface of the sidewall facing the light incident surface defines a plurality of elastic members thereon according to the point light sources. Each elastic member pushes the corresponding point light source towards the light guide plate, so as to have the final position of the emitting surface of each point light source come in contact with the light incident surface.

Other advantages and novel features will become more apparent from the following detailed description of the preferred embodiments, when taken in conjunction with the accompanying drawings.

### BRIEF DESCRIPTION OF THE DRAWINGS

Many aspects of the present backlight module can be better understood with reference to the following drawings. The components in the drawings are not necessarily drawn to scale, the emphasis instead being placed upon clearly illustrating the principles of the present backlight module. Moreover, in the drawings, like reference numerals designate corresponding parts throughout the several views.

FIG. 1 is a schematic, top plan view of a backlight module according to a first preferred embodiment;

FIG. 2 is a schematic, top plan view of a FPCB fixed with a plurality of LEDs of FIG. 1;

FIG. 3 is a schematic, top plan view of a backlight module according to a second preferred embodiment;

FIG. 4 is a schematic, top plan view of a backlight module according to a third preferred embodiment;

FIG. 5 is a schematic, top plan view of a backlight module according to a fourth preferred embodiment;

FIG. 6 is a schematic, top plan view of a conventional backlight module;

FIG. 7 is a schematic, top plan view of a FPCB fixed with a plurality of LEDs of FIG. 6; and

FIG. 8 is a schematic, top plan view of another conventional backlight module.

### DETAILED DESCRIPTION OF THE PREFERRED EMBODIMENTS

Reference will now be made to the drawings to describe in detail preferred embodiments of the present backlight module.

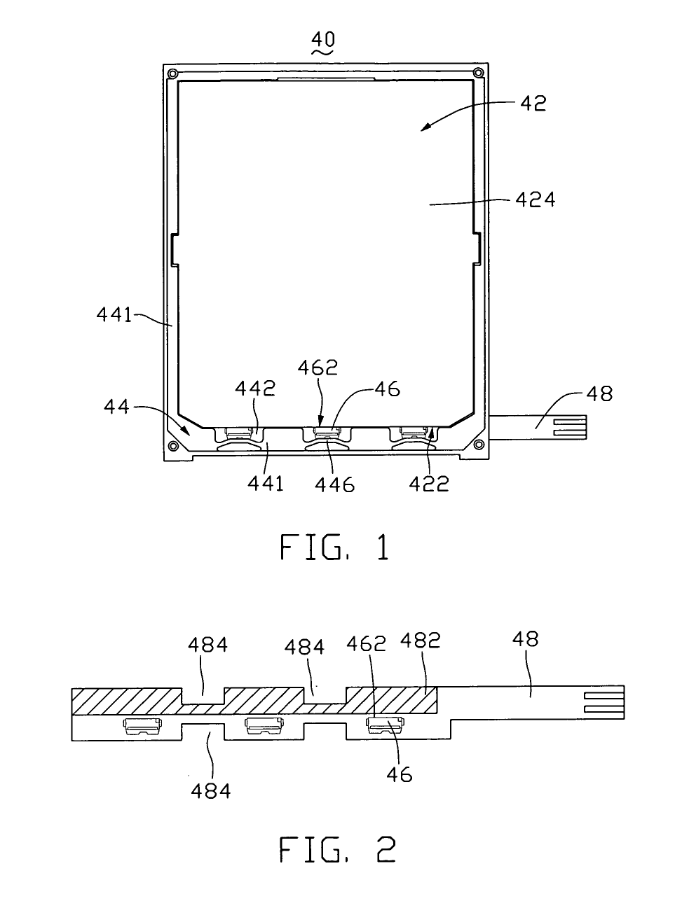

Referring to FIG. 1, a backlight module 40 in accordance with a preferred embodiment is shown. The backlight module 40 includes a light guide plate 42, a frame 44, three LEDs 46 and a FPCB 48. The light guide plate 42 is a rectangular sheet, or alternatively may be generally cuneiform. The light guide plate 42 includes a light emitting surface 424 and a bottom surface (not labeled) on opposite sides thereof, and further includes a light incident surface 422 adjoining the light emitting surface 424 and the bottom surface. The frame 44 includes four connecting sidewalls 441 encircling the light guide plate. An inner surface of the sidewall 441 facing the light incident surface 422 defines three frame cutouts 442 therein for receiving corresponding LEDs 46. Each frame cutout 442 defines an elastic member 446 therein. In this embodiment, the elastic member 446 is an elastic bridge extending from a section of an inner side surface of each frame cutout 442 towards an opposite inner side surface of each frame cutout 442. The elastic bridge interconnects the two opposite inner side surface of each frame cutout 442.

Referring to FIG. 2, the FPCB 48 is generally long and thin. The FPCB 48 could be selected from one of a copper clad laminate or a tape carrier package. The FPCB 48 includes a plurality of electrical components (not shown) formed on one surface thereof to control the operations of LEDs 46 or other components. The three LEDs 46 are welded on the FPCB 48 in an array along a direction parallel to the light incident surface 422, corresponding to the frame cutouts 442 so as to electrically connect with the electrical component of the FPCB 48. A distance between two adjacent LEDs 46 is configured to be larger than or equal to a distance between two adjacent frame cutouts 442, hence, the LED 46 could be confined in the frame cutout 442. The LEDs 46 each has an emitting surface 462 facing the same side of the FPCB 48. The FPCB 48 further defines a plurality of cutouts 484 at the two opposite edges thereof, specifically, the two cutouts 484 on the two opposite edges of the FPCB 48 faces each other and located between two adjacent LEDs 46 correspondingly.

The FPCB 48 can be fixed to the bottom surface of the light guide plate 42 with a double-coated adhesive tape 482. An adhesive surface of the double-coated adhesive tape 482 adheres to the surface of the FPCB 48 on a side adjacent to the emitting surfaces of the LEDs 46, and another opposite adhesive surface of the double-coated adhesive tape 482 could adhere to the bottom surface of the light guide plate 42 adjacent the light incident surface 422.

When the backlight module 40 is assembled, the light guide plate 42 is first mounted into the frame 44. Afterwards, the FPCB 48 welded with the LEDs 46 is attached to the light guide plate 42. The adhesive surface of the double-coated adhesive tape 482 adheres to the bottom surface of the light guide plate 42 on the side adjacent to the light incident surface 422. Finally, the LEDs 46 are inserted into the frame cutouts 442 correspondingly. When the LEDs 46 are confined in the corresponding frame cutouts 442, the LEDs 46 are pushed by the elastic members 446 producing a force along a direction facing an inner area of the frame 44, thereby the FPCB 48 and the LEDs 46 may have slight displacements when the emitting surface of each LED 46 is finally positioned in contact with the light incident surface 422 of the light guide plate 42. Accordingly, few light rays from the LEDs 46 escapes through gaps between the light guide plate 42 and the LEDs 46. In addition, when one of the LEDs 46 has a slight displacement along a direction facing an inner area of the frame 44 due to the elastic member 446, other adjacent LEDs 46 has less bad influence because the plurality of cutouts 484 between the two adjacent LEDs 46 would decrease a displacement of the FPCB 48.

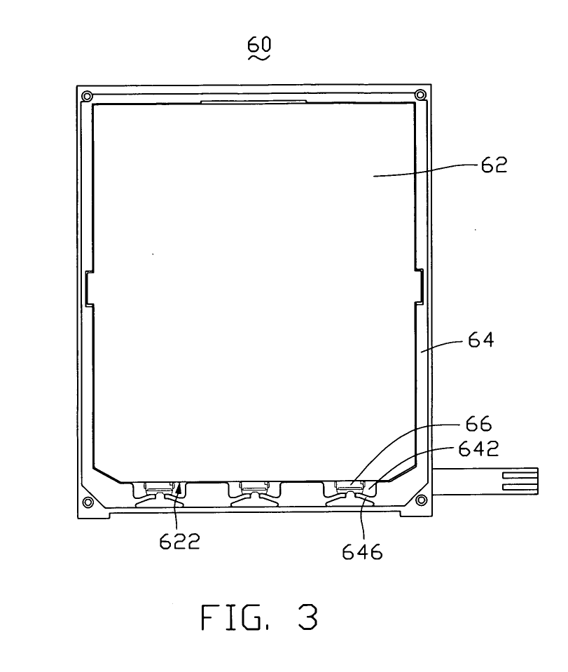

Referring to FIG. 3, a backlight module 60 in accordance with a second preferred embodiment is shown. The backlight module 60 is similar in principle to that of the first embodiment, except that elastic member 646 of each frame cutout 642 of a frame 64 is different from the elastic member 446 of the first embodiment. Each elastic member 646 includes two elastic arms extending from a part of two opposite inner side surfaces of each frame cutout 642 towards a center portion of each frame cutout 642 correspondingly. LEDs 66 are pushed by the two elastic arms producing a force along direction facing an inner area of the frame 64, thereby the LEDs 66 may have a slight displacement when the emitting surface of each LED 66 is finally positioned in contact with a light incident surface 622 of a light guide plate 62. It is to be understood that each elastic member 646 having only one elastic arm should be considered to be within the scope of the present invention.

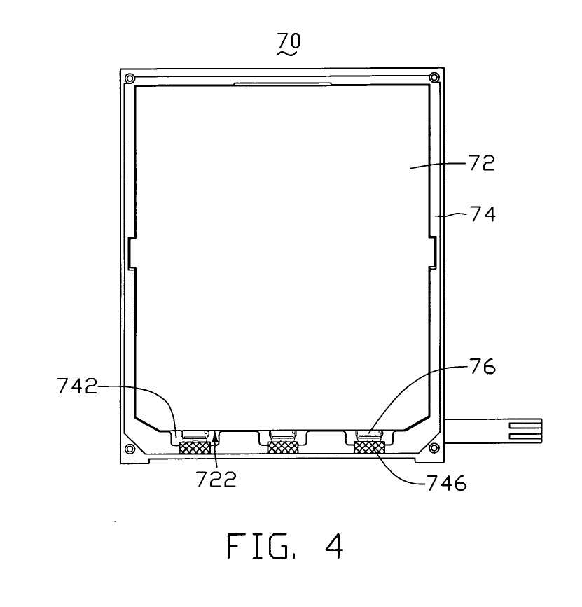

Referring to FIG. 4, a backlight module 70 in accordance with a third preferred embodiment is shown. The backlight module 70 is similar in principle to that of the first embodiment, except that elastic members 746 of each frame cutout 742 of a frame 74 are different from the elastic members 446 of the first embodiment. Each elastic member 746 is an elastic block disposed at a bottom portion of each frame cutout 742. A material of the elastic block is selected from kinds of elastic materials such as rubber and so on. LEDs 76 are pushed by the elastic block producing a force along direction facing an inner area of the frame 74, thereby the LEDs 76 may have a slight displacement before the emitting surface of each LED 76 is finally positioned in contact with a light incident surface 722 of a light guide plate 72.

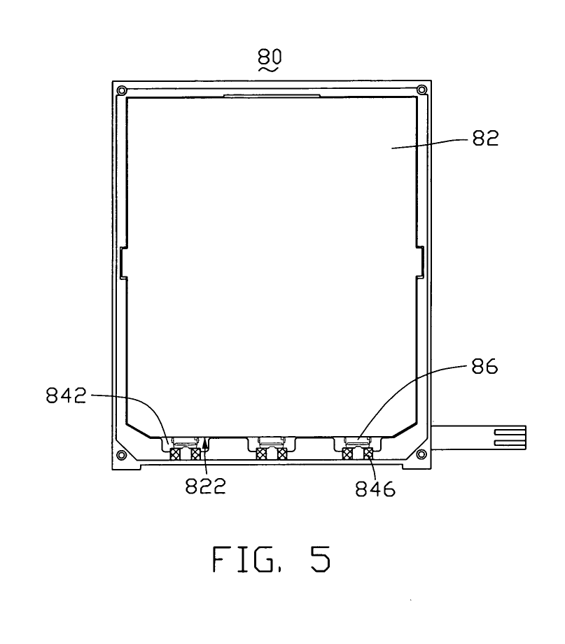

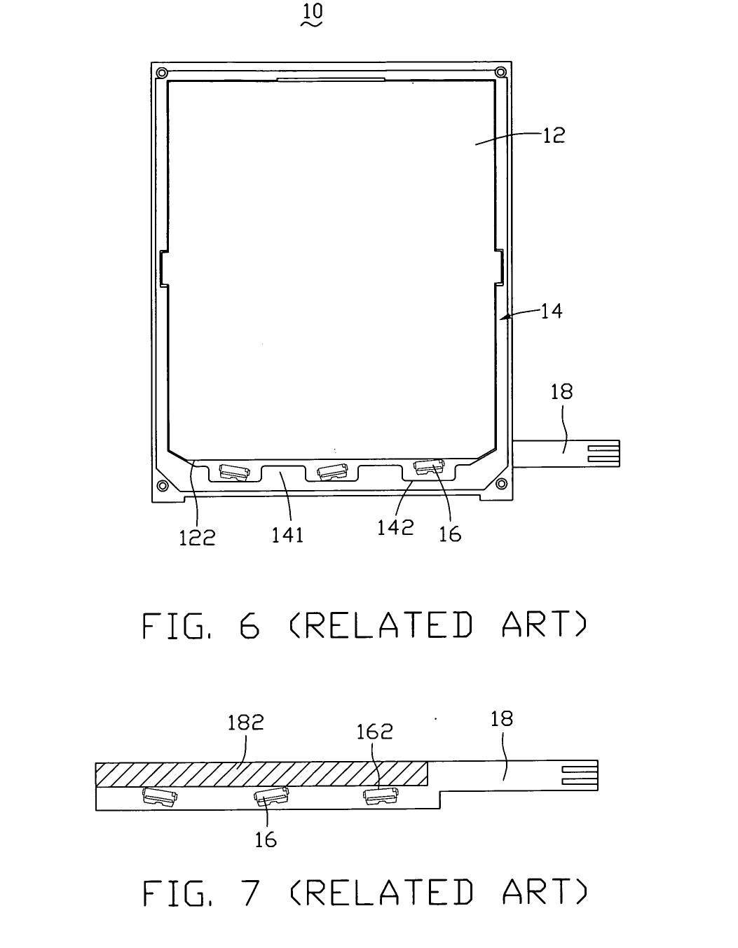

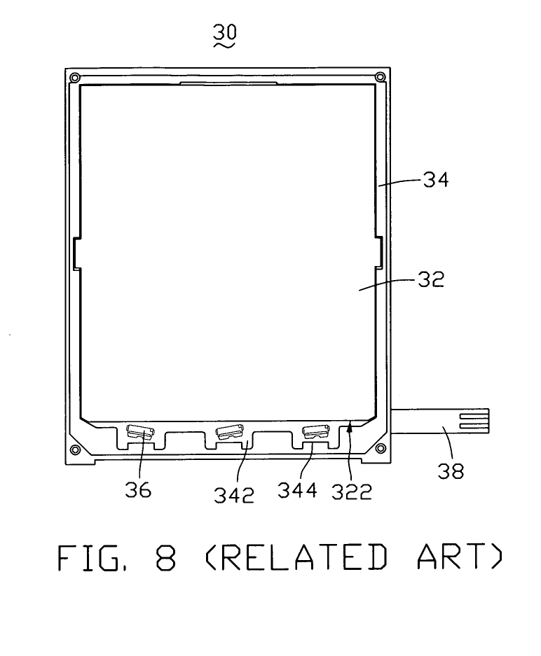

Referring to FIG. 5, a backlight module 80 in accordance with a fourth preferred embodiment is shown. The backlight module 80 is similar in principle to that of the third embodiment, except that elastic members 846 of each frame cutout 842 are different from the elastic members 746 of the third embodiment. Each elastic member 846 includes two elastic block disposed at a bottom portion of each frame cutout 842 adjacent to two opposite side surfaces of each frame cutout 842 correspondingly. The elastic block of the elastic member 846 is smaller than that of the elastic member 746. LEDs 86 are pushed by the elastic blocks producing forces along direction facing an inner area of the frame 84 is produced, thereby the LEDs 86 may have a slight displacement before the emitting surface of each LED 86 is finally positioned in contact with a light incident surface 822 of a light guide plate 82.

It should be pointed out that the elastic member of the present backlight module is not limited to the illustrated embodiments. A spring can also be employed as the elastic member of the present backlight module, or a combination of the spring, elastic bridge, elastic arms, at least one elastic block can also be employed in the present backlight module.

It should be pointed out that the frame cutouts defined in the inner surface of the sidewall of the frame may also be omitted. The elastic members being positioned on the inner surface of the sidewall directly, should be considered to be within the scope of the present invention. It is to be understood that the cutouts of the FPCB of the present backlight module may also be omitted if the LEDs are positioned on the FPCB precisely. The FPCB without the cutouts should be considered to be within the scope of the present invention.

A material of the light guide plate 31 is selected from a group comprising of polymethyl methacrylate (PMMA), polycarbonate (PC), or other suitable transparent resin materials.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
a light guide plate having a light incident surface;
a flexible printed circuit board;
a plurality of point light sources electrically connected with one surface of the flexible printed circuit board, each point light source having an emitting surface; and
a frame having a plurality of connecting sidewalls encircling the light guide plate, wherein an inner surface of the sidewall facing the light incident surface defines a plurality of elastic members thereon according to the point light sources, each elastic member pushes the corresponding point light source towards the light guide plate, so as to have the final position of the emitting surface of each point light source come in contact with the light incident surface.

2. The backlight module according to claim 1, wherein an inner surface of the sidewall adjacent to and facing the light incident surface of the light guide plate defines three frame cutouts therein for receiving corresponding point light sources, the elastic member being positioned in each frame cutout.

3. The backlight module according to claim 2, wherein each elastic member is an elastic bridge extending from a section of an inner side surface of each frame cutout an opposite inner side surface of each frame cutout, the elastic bridge interconnecting the two opposite inner side surface of each frame cutout.

4. The backlight module according to claim 2, wherein each elastic member comprises at least one elastic arm extending from a part of an inner side surface of each frame cutout towards a center portion of each frame cutout correspondingly.

5. The backlight module according to claim 2, wherein each elastic member comprises at least an elastic block disposed at a bottom portion of each frame cutout.

6. The backlight module according to claim 2, wherein each elastic member is a spring disposed at a bottom portion of each frame cutout.

7. The backlight module according to claim 1, wherein the flexible printed circuit board further defines a plurality of cutouts at the two opposite edges thereof, the cutouts being located between the two adjacent point light sources correspondingly.

8. The backlight module according to claim 1, wherein the flexible printed circuit board with the point light sources are attached to the light guide plate by a double-coated adhesive tape, one adhesive surface of the double-coated adhesive tape adhering to the surface of the flexible printed circuit board on the same side of the emitting surfaces of the point light sources, and another opposite adhesive surface of the double-coated adhesive tape adhering to a bottom surface adjacent the light incident surface of the light guide plate.

9. The backlight module according to claim 1, wherein the point light source is light emitting diode.

10. The backlight module according to claim 1, wherein the light guide plate is a rectangular sheet, or alternatively may be generally cuneiform.

11. The backlight module according to claim 1, wherein a material of the light guide plate is selected from a group comprising of polymethyl methacrylate, polycarbonate, or other suitable transparent resin materials.

12. A backlight module comprising:
a light guide plate having a light incident surface;
a plurality of point light sources arranged to emit light rays toward the light incident surface, each point light source having an emitting surface; and
a plurality of elastic members each resiliently urging a corresponding one of the point light sources toward the light incident surface in a manner so as to achieve a complete contact of the emitting surface with the light incident surface.

13. The backlight module of claim 12, wherein a frame is disposed surrounding the light guide plate, and the elastic members are formed on the frame.

14. The backlight module of claim 13, wherein each elastic member is a resilient arm.

15. The backlight module of claim 12, wherein a frame is disposed surrounding the light guide plate, and the elastic members are compressed between the elastic members and the frame.
